(19) United States
(12) Patent Application Publication
(10) Pub. No.: US 2024/0195590 A1
(43) Pub. Date: Jun. 13, 2024

(54) METHOD AND APPARATUS FOR DATA TRANSMISSION IN FULL DUPLEX MODE

(71) Applicant: LENOVO (BEIJING) LIMITED, Beijing (CN)

(72) Inventors: Yuantao Zhang, Beijing (CN); Hongmei Liu, Beijing (CN); Zhi Yan, Beijing (CN); Haiming Wang, Beijing (CN)

(21) Appl. No.: 18/553,621

(22) PCT Filed: Apr. 2, 2021
(86) PCT No.: PCT/CN2021/085279

§ 371 Date: Oct. 2, 2023

(51) Int. Cl. H04L 5/00

(52) U.S. Cl. CPC H04L 5/0092

(57) ABSTRACT

The present application relates to a method and an apparatus for data transmission in full duplex mode. One embodiment of the present disclosure provides a of a user equipment (UE) for transceiving with a base station with full duplex capability, comprising: determining a first plurality of bandwidth parts (BWPs) for a first set of slots, wherein the first set of slots are preconfigured for a first link; and receiving, from the base station, a configuration indicating utilizing a first BWP for the first set of slots for a second link, wherein the first link is one of uplink and downlink and the second link is the other one of uplink and downlink.

### TECHNICAL FIELD

The present disclosure relates to the 3rd Generation Partnership Project (3GPP) 5G new radio (NR), especially to a method and an apparatus for data transmission in full duplex (FD) mode.

### BACKGROUND OF THE INVENTION

In theory, FD system has a potential to double the link throughput of its half-duplex counterparts. Besides, the transmission latency is also reduced due to bidirectional transmission in each time slot.

Therefore, it is desirable to provide a solution for the data transmission in full duplex mode in 5G NR.

### SUMMARY

One embodiment of the present disclosure provides a method of a user equipment (UE) for transceiving with a base station with full duplex capability, comprising: determining a first plurality of bandwidth parts (BWPs) for a first set of slots, wherein the first set of slots are preconfigured for a first link; and receiving, from the base station, a configuration indicating utilizing a first BWP for the first set of slots for a second link, wherein the first link is one of uplink and downlink and the second link is the other one of uplink and downlink.

In one embodiment of the present disclosure, the first BWP is included in a first additional plurality of BWPs.

In one embodiment of the present disclosure, the method further comprising: performing data transmission with at least one of the first plurality of BWPs for the first link and the first BWP for the second link in a same slot.

In one embodiment of the present disclosure, the method further comprising: determining a second plurality of BWPs for a second set of slots, wherein the second set of slots are preconfigured for the second link.

In one embodiment of the present disclosure, the configuration further indicates utilizing a second BWP for the second set of slots for the first link.

In one embodiment of the present disclosure, the second BWP is selected from a second additional plurality of BWPs for the first link.

In one embodiment of the present disclosure, the method further comprising: performing data transmission with at least one of the first plurality of BWPs for the first link and the first BWP for the second link in a same slot; and performing data transmission with at least one of the second plurality of BWPs for the second link and the second BWP for the first link in a same slot.

In one embodiment of the present disclosure, the method further comprising: each of the first plurality of BWPs has a same center frequency as a corresponding one in the second plurality of BWPs.

In one embodiment of the present disclosure, the method further comprising: each of the first plurality of BWPs is paired with a corresponding one in the second plurality of BWPs, which has a same BWP ID.

In one embodiment of the present disclosure, the configuration is associated with an RRC signalling with a bitmap.

In one embodiment of the present disclosure, the configuration is associated downlink control information (DCI).

In one embodiment of the present disclosure, the DCI is group common DCI or UE-specific DCI.

In one embodiment of the present disclosure, the DCI is scrambled with a new radio network temporary identity (RNTI).

In one embodiment of the present disclosure, the configuration further indicates a first time duration for activating the first BWP.

In one embodiment of the present disclosure, the configuration further indicates a second time duration for deactivating the first BWP.

In one embodiment of the present disclosure, each of the BWP in the first plurality of the BWPs is associated with a corresponding BWP of a first additional plurality of the BWPs configured for the UE, and a first BWP in the first plurality of the BWPs is associated with a first BWP of the first additional plurality of the BWPs.

In one embodiment of the present disclosure, if BWP switching happens between two BWPs in the first plurality of BWPs, BWP switching happens between two BWPs in the first additional plurality of BWPs associated with the two BWPs in the first additional plurality of BWPs.

In one embodiment of the present disclosure, the method further comprising: when a gap between a BWP obtained after the BWP switching in the first plurality of BWPs and a BWP obtained after the BWP switching in the first additional plurality of BWP is less than a threshold, deactivating the BWP obtained after the BWP switching in the first additional plurality of BWP.

In one embodiment of the present disclosure, the method further comprising: upon initiation of a Random Access Channel (RACH) procedure, deactivating utilization of the first BWP if Physical Random Access Channel (PRACH) occasions are not configured in both the first BWP in the first plurality of the BWPs and the first BWP of the first additional plurality of the BWPs.

In one embodiment of the present disclosure, the method further comprising: upon switching from a first BWP to a second BWP in the first plurality of the BWPs, deactivating the first BWP in the first additional plurality of the BWPs if no BWP in the first additional plurality of the BWPs is associated with the second BWP. Another embodiment of the present disclosure provides a method for a base station, comprising: determining a first plurality of bandwidth parts (BWPs) for a first set of slots, wherein the first set of slots are preconfigured for a first link; and transmitting, to a user equipment (UE), a configuration indicating utilizing a first BWP for the first set of slots for a second link, wherein the first link is one of uplink and downlink and the second link is the other one of uplink and downlink.

In one embodiment of the present disclosure, the first BWP is included in a first additional plurality of BWPs.

In one embodiment of the present disclosure, the method further comprising: determining a second plurality of BWPs for a second set of slots, wherein the second set of slots are preconfigured for the second link.

In one embodiment of the present disclosure, the configuration further indicates utilizing a second BWP for the second set of slots for the first link.

In one embodiment of the present disclosure, the second BWP is selected from a second additional plurality of BWPs for the first link.

In one embodiment of the present disclosure, the method further comprising: each of the first plurality of BWPs has a same center frequency as a corresponding one in the second plurality of BWPs.

In one embodiment of the present disclosure, the method further comprising: each of the first plurality of BWPs is paired with a corresponding one in the second plurality of BWPs, which has a same BWP ID.

In one embodiment of the present disclosure, the configuration is associated with an RRC signalling with a bitmap.

In one embodiment of the present disclosure, the configuration is associated downlink control information (DCI).

In one embodiment of the present disclosure, the DCI is group common DCI or UE-specific DCI.

In one embodiment of the present disclosure, the DCI is scrambled with a new radio network temporary identity (RNTI).

In one embodiment of the present disclosure, the configuration further indicates a first time duration for activating the first BWP.

In one embodiment of the present disclosure, the configuration further indicates a second time duration for deactivating the first BWP.

In one embodiment of the present disclosure, each of the BWP in the first plurality of the BWPs is associated with a corresponding BWP of a first additional plurality of the BWPs configured for the UE, and a first BWP in the first plurality of the BWPs is associated with a first BWP of the first additional plurality of the BWPs.

In one embodiment of the present disclosure, if BWP switching happens between two BWPs in the first plurality of BWPs, BWP switching happens between two BWPs in the first additional plurality of BWPs associated with the two BWPs in the first additional plurality of BWPs.

In one embodiment of the present disclosure, the method further comprising: when a gap between a BWP obtained after the BWP switching in the first plurality of BWPs and a BWP obtained after the BWP switching in the first additional plurality of BWP is less than a threshold, deactivating the BWP obtained after the BWP switching in the first additional plurality of BWP.

In one embodiment of the present disclosure, the method further comprising: upon initiation of a Random Access Channel (RACH) procedure, deactivating utilization of the first BWP if Physical Random Access Channel (PRACH) occasions are not configured in both the first BWP in the first plurality of the BWPs and the first BWP of the first additional plurality of the BWPs.

In one embodiment of the present disclosure, the method further comprising: upon switching from a first BWP to a second BWP in the first plurality of the BWPs, deactivating the first BWP in the first additional plurality of the BWPs if no BWP in the first additional plurality of the BWPs is associated with the second BWP.

Yet another embodiment of the present disclosure provides an apparatus, comprising: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the method of a user equipment (UE) for transceiving with a base station with full duplex capability, comprising: determining a first plurality of bandwidth parts (BWPs) for a first set of slots, wherein the first set of slots are preconfigured for a first link; and receiving, from the base station, a configuration indicating utilizing a first BWP for the first set of slots for a second link, wherein the first link is one of uplink and downlink and the second link is the other one of uplink and downlink.

### BRIEF DESCRIPTION OF THE DRAWINGS

FIG. 1 illustrates a schematic diagram of a wireless communication system according to some embodiments of the present disclosure.

FIGS. 2A-2E illustrate five different duplex modes according to some embodiments of the present disclosure.

FIG. 3 illustrates a communication system with UEs that support the FD and UEs that do not support the FD according to some embodiments of the present disclosure.

FIG. 4 illustrates a configuration of additional BWP in a set of slots according to some embodiments to the present disclosure.

FIGS. 5A-5C illustrate three embodiments of dynamically indicating the activation of one or more additional DL BWPs, the activation of one or more additional UL BWPs, or the activation of one or more DL and UL additional BWPs according to some embodiments of the present disclosure.

FIG. 6 illustrates an example of BWP switching between a legacy BWP and an additional BWP with BWP association according to some embodiments of the present disclosure.

FIG. 7 illustrates an example of BWP switching from a legacy DL BWP in a legacy DL slot to a UL BWP based on an indication in BWP switching.

FIG. 8 illustrates a method performed between a UE and a BS for wireless communication according to a preferred embodiment of the present disclosure.

FIG. 9 illustrates a block diagram of an apparatus according to the embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that all illustrated operations be performed, to achieve desirable results, sometimes one or more operations can be skipped. Further, the drawings can schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

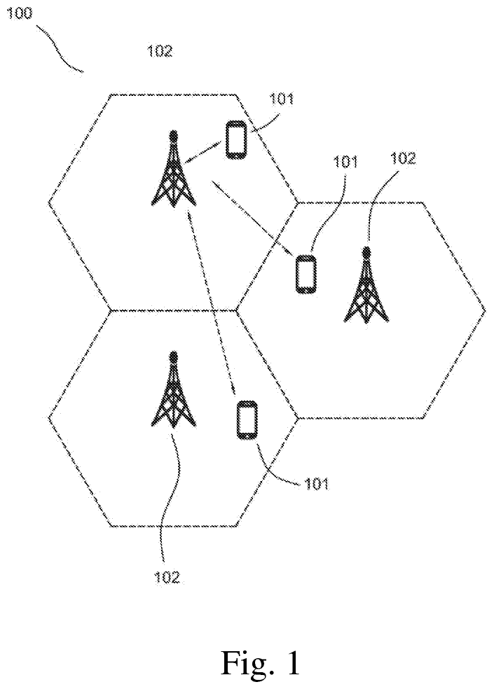

FIG. 1 depicts a wireless communication system 100 according to an embodiment of the present disclosure.

As shown in FIG. 1, the wireless communication system 100 includes UE 101 and BS 102. In particular, the wireless communication system 100 includes three UEs 101 and three BSs 102 for illustrative purpose only. Even though a specific number of UEs 101 and BSs 102 are depicted in FIG. 1, one skilled in the art will recognize that any number of UEs 101 and BSs 102 may be included in the wireless communication system 100.

The UEs 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present disclosure, the UEs 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UEs 101 include wearable devices, such as smart watches, fitness bands, optical head-mounted displays, or the like. Moreover, the UEs 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UEs 101 may communicate directly with the BSs 102 via uplink (UL) communication signals.

The BSs 102 may be distributed over a geographic region. In certain embodiments, each of the BSs 102 may also be referred to as an access point, an access terminal, a base, a macro cell, a Node-B, an enhanced Node B (eNB), a gNB, a Home Node-B, a relay node, or a device, or described using other terminology used in the art. The BSs 102 are generally part of a radio access network that may include one or more controllers communicably coupled to one or more corresponding BSs 102.

The wireless communication system 100 is compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In one embodiment, the wireless communication system 100 is compatible with the 5G new radio (NR) of the 3GPP protocol, wherein the BSs 102 transmit data using an orthogonal frequency division multiplexing (OFDM) modulation scheme on the downlink and the UEs 101 transmit data on the uplink using Discrete Fourier Transform-Spread-Orthogonal Frequency Division Multiplexing (DFT-S-OFDM) or Cyclic Prefix-Orthogonal Frequency Division Multiplexing (CP-OFDM) scheme. More generally, however, the wireless communication system 100 may implement some other open or proprietary communication protocols, for example, WiMAX, among other protocols.

In other embodiments, the BSs 102 may communicate using other communication protocols, such as the IEEE 802.11 family of wireless communication protocols. Further, in some embodiments, the BSs 102 may communicate over licensed spectrums, whereas in other embodiments the BSs 102 may communicate over unlicensed spectrums. The present disclosure is not intended to be limited to the implementation of any particular wireless communication system architecture or protocol. In another embodiment, the BSs 102 may communicate with the UEs 101 using the 3GPP 5G protocols.

Duplex communication means bidirectional communication between two devices. There are two types of duplex communication, one is the full duplex, which suggests that the transmissions over the link in each direction may take place at the same time, the other is half duplex, which means that the transmissions over the link in each direction may take place at mutual exclusive time.

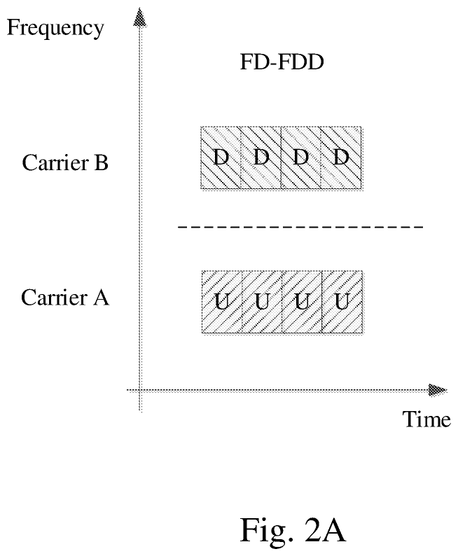

FIGS. 2A-2E illustrate five different duplex modes according to some embodiments of the present disclosure. FIG. 2A illustrates a full duplex frequency division duplex (FD-FDD) mode. The capital “U” represents the uplink transmission, and the letter “D” represents the downlink transmission, the uplink data is transmitted using carrier A, and the downlink data is transmitted using carrier B. That is, the full duplex is achieved by different carrier frequencies.

FIG. 2B illustrates a time division duplex (TDD) mode. When the same carrier frequency is used for each link direction, the HD transceiver is referred to be TDD system, while if different carrier frequencies are used, the system is half duplex FDD (HD-FDD) mode as shown in FIG. 2C. In the case of HD transceiver, the link directions are separated by time domain resources.

FIGS. 2D and 2E illustrate full duplex modes which enable transmission and reception by the same device on the same carrier in the same slot. For example, in FIG. 2D, the uplink and downlink occupy different frequency resources in the same carrier, carrier A. For the same slot, there is a gap in frequency domain in FIG. 2D. FIG. 2E illustrates another full duplex mode, the uplink and downlink could occupy fully overlapped resources, and there is no gap in frequency domain.

The usage of the FD modes in FIGS. 2D and 2E depends on the UE capability of self-interference cancellation for FD, i.e., the interference from the transmitted signal to the received signal in the same resource. Since there is a gap in frequency domain in FD mode in FIG. 2D that helps alleviating the interference, the self-interference for the FD mode in FIG. 2D is lower than that in FIG. 2E.

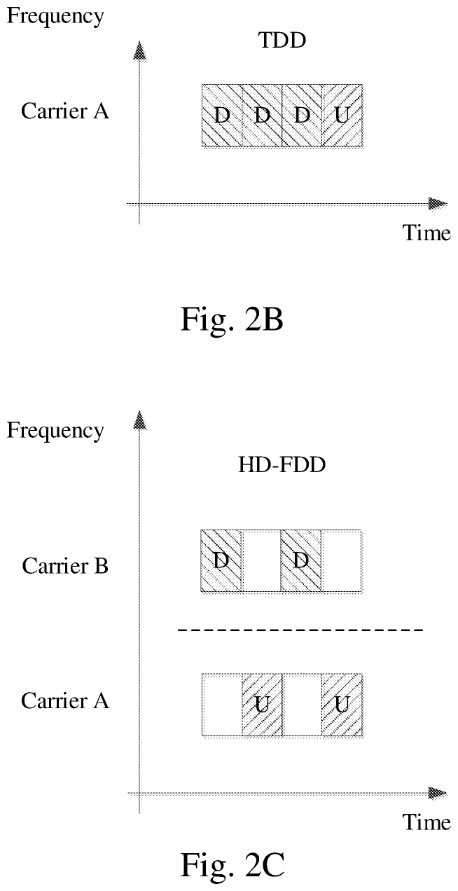

FIG. 3 illustrates a communication system with UEs that support the FD and UEs that do not support the FD according to some embodiments of the present disclosure. In FIG. 3, the BS support the FD, UE1 is a UE which is capable of perform the full duplex operations, while UE2 is a legacy UE, which means UE2 is not capable of perform the full duplex operations. Therefore, the duplex mode is discussed separately at BS side and at UE side. Specifically, support of UEs with full duplex in the system also needs full duplex in the BS, but NOT vice versa. For example, the FD modes as shown in FIGS. 2D and 2E at BS side does not mean the UEs need to be capable of full duplex. In case the UL and DL resources in such modes are allocated for different UEs in the system, the BS need to transmit and receive in one time slot, which needs the full duplex capability, but the UE does not need such operation.

In FIG. 3, BS may perform full duplex data transmission with UE1, and is in bidirectional link in a carrier and could transmit and receive in the same slot. UE2 is in DL transmission in the same carrier, thus there is an interference from the UL transmitted signal from UE1 to the DL reception at UE2 side.

In order to support full duplex communications, the present disclosure proposes resource allocations of DL and UL transmission to support full duplex operations. More specifically, the present disclosure relates to BWP configuration, activation, and/or switching framework for full duplex.

As explained above, some UEs may support the FD mode, while other UEs not. Therefore, there are at least two different scenarios, one is that both the BS and the UE support the FD mode, and the other is only the BS supports the FD mode.

In the case that full duplex supported in both UE side and in BS side, besides the legacy DL bandwidth part (BWP) configured for each DL slot and the UL BWP configured for each UL slot, a full duplex capable UE could be configured with at least one additional bandwidth part for at least one time slot out of a plurality of slots, and the additional BWP has a different link direction with that of the legacy BWP in the same slot.

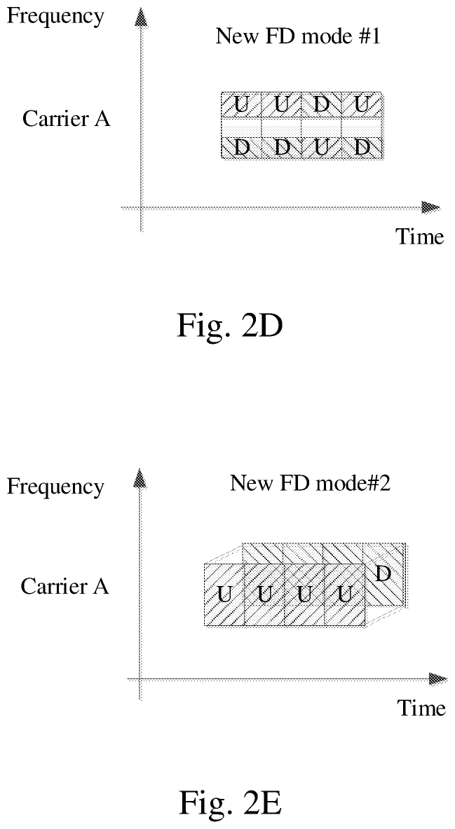

FIG. 4 illustrates a configuration of additional BWP in a set of slots according to some embodiments to the present disclosure.

In FIG. 4, a frame structure is illustrated, where there are 10 slots numbered as #0, #1, #2, . . . , #9 for a UE capable of full duplex, which are configured as “D, D, D, S, U, D, D, D, S, U”, wherein “D” suggests that the slot is for downlink data transmission, “U” suggests that the slot is for uplink data transmission, “S” suggests that the slot is a special slot, the expression “(FD)” suggests that the slot is a full duplex slot for the UEs with full duplex capability. It should be noted such frame structure is just an example for describing the invention. And the invention does not depend on which frame structure is utilized. The present disclosure also applies to other frame structures in addition to the frame structure depicted in FIG. 4.

Based on a configuration, a downlink and/or an uplink additional BWP might be available in the set of time slots. In one embodiment, the slots with an available additional BWP are configured semi-statically, for example, the additional BWP may be configured based on e.g., a bitmap in a RRC signalling. Each bit in the bitmap indicates if there is an available additional BWP in the associated time slot. In FIG. 4, the bitmap is “0100101001,” which indicates the availability of the additional BWP in each of ten slots. The slots corresponding to bit “1” are configured with additional BWPs and the slots with “0” are not. According to FIG. 4, slot #1, slot #4, slot #6, slot #9 are configured with additional BWPs, and an additional UL BWP is available for legacy DL slot #1 and slot #6, and an additional DL BWP is available for legacy UL slot #4 and slot #9. Therefore, in a slot with an additional BWP, two BWPs with different link direction are available and the FD UE could transmit and receive in the same slot. In other embodiments, although a slot may be configured with an additional BWP, the slot may actually include a legacy BWP only, an additional BWP only, or a legacy BWP and an additional BWP both.

In another embodiment, the slots with an available additional BWP are indicated dynamically through e.g., physical layer (PHY) signalling. In other words, the activation of the additional BWPs is indicated dynamically through PHY signalling. For example, a downlink control information (DCI) is defined for the activation, and has a bit field to indicate the activation/deactivation of an additional DL BWP, or the activation of an additional UL BWP, or the activation of both DL and UL additional BWPs. For example, the bit field in the DCI has two bits, each is associated with an additional DL BWP and an additional UL BWP. Bit “O” indicates the deactivation of an additional BWP and bit “1” indicates the activation of an additional BWP.

In another embodiment, the DCI may include separate bit filed for activation and deactivation of an additional DL BWP, or an additional UL BWP, or both the additional DL BWP and UL BWP, if configured.

The DCI may still include another bit field, which is used indicate a time duration for the availability of one or more of the additional BWPs. If both additional DL and UL BWP are configured, the time duration may be separately indicated for the additional DL BWP and for the additional UL BWP, or the DCI only indicates one time duration, which is used for both the additional DL BWP and the additional UL BWP.

Alternatively, there may be a predefined or pre-configured timer. Once activated by the DCI, an additional BWP is available before the expiration of the timer. The timer might be separately configured for the additional DL BWP and the additional UL BWP, that is, there is one timer for the additional DL BWP, and another timer for the UL BWP. When the timer expires, the additional BWP is deactivated automatically. Or, the timer may be configured for both the additional DL BWP and the additional UL BWP. For example, there is only one timer configured for both the additional DL BWP and the additional UL BWP.

The DCI for indicating of the activation of an additional BWP, may be a group common DCI, or a UE specific DCI. In the present disclosure, a new RNTI is proposed to scramble the DCI and is also used for the UE to identify the DCI.

In another embodiment, an RRC signaling indicates an additional BWP in a set of slots, while when the additional BWP is activated is indicated by the PHY layer signaling, i.e., a DCI.

Referring back to FIG. 4, among the 10 slots, the downlink slot #1 is marked as “D(FD)”, which suggests this slot is configured with at least one additional BWP, more specifically, in addition to the legacy BWP #1 configured for a UE, which is used for downlink transmission, this downlink slot is further configured with an additional BWP #5 for the same UE, which is used for uplink data transmission. That is to say, in this slot, downlink transmission is performed in BWP #0, and uplink transmission is performed in BWP #5.

Similarly, the uplink slot #4, which is marked as “U(FD)”, which suggests this slot is configured with at least one additional BWP, more specifically, in addition to the legacy BWP #0 configured for a UE, which is used for uplink transmission, this uplink slot is further configured with an additional BWP #5 for the same UE, which is used for downlink data transmission. That is to say, in this slot, uplink transmission is performed in BWP #0, and downlink transmission is performed in BWP #5.

The at least one additional BWPs is configured from a set of additional BWPs. There may be one set of additional BWPs configured for DL and another set of BWPs configured for UL, or the additional BWPs for DL and UL are in the same set. The UE may be configured with either one additional DL BWP, or one additional UL BWP, or both DL and UL additional BWPs, based on traffic needs.

For example, the additional BWP #5 in slot #1 may be configured from a set of additional BWPs configured for uplink data transmission, alternatively, the additional BWP #5 in slot #1 may be selected from another set of additional BWPs configured for both the uplink data transmission and downlink data transmission. The additional BWP #5 in slot #4 may be selected from a set of additional BWPs configured for downlink data transmission, alternatively, the additional BWP #5 in slot #4 may be selected from another set of additional BWPs configured for both the uplink data transmission and downlink data transmission.

In a network with unpaired spectrum, for example, the TDD system, if both additional DL BWP and additional UL BWP are configured for a UE which is capable of full duplex, they are paired, which means that the additional DL BWP and the additional UL BWP have the same center frequency and the same BWP index. The additional BWPs for DL or UL are indexed from a predefined starting ID. As depicted in FIG. 4, the additional UL BWP in slot #1 and the additional DL BWP in slot #4 are paired. The additional UL BWP #5 in slot #1 and the additional DL BWP #5 in slot #4 have the same center frequency and the same BWP ID, i.e. BWP ID #5. In some embodiments, when the slot transits from DL to UL, the additional DL BWP automatically becomes available in the configured legacy UL slots, or when the slot transits from UL to DL, the additional UL BWP automatically becomes available in the configured legacy DL slots.

In another embodiment, an additional BWP might be activated for data transmission in a slot based on scheduling information received. For example, if the UE receives a DCI scheduling a UL transmission in a DL slot, the UE activates the additional UL BWP for UL transmission in the slot. Similarly, if a DCI is received for scheduling a DCI transmission in a UL slot, the UE activates the additional UL BWP for DL transmission in the slot.

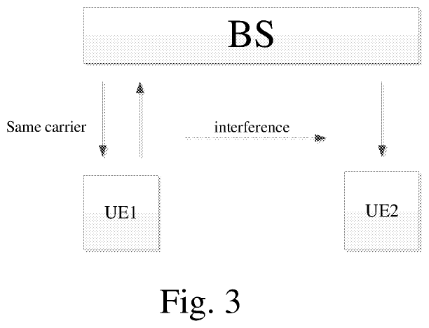

FIGS. 5A-5C illustrate three embodiments of dynamically indicating the activation of one or more additional DL BWPs, the activation of one or more additional UL BWPs, or the activation of one or more DL and UL additional BWPs according to some embodiments of the present disclosure. The blocks marked with “D” represent the DL slots, the blocks marked with “S” represent the special slots, and the blocks marked with “U” represent the UL slots.

In FIG. 5A, a UE receives a DCI in the first slot among the slots in FIG. 5A, which dynamically indicates the activation of one or more additional DL BWP. In particular, the DCI indicates activates the additional UL BWP in legacy DL slots and special slots, which are both marked with dashed lines. Here the special slots are configured to be available for DL transmission so the configuration of additional UL BWP applies for special slots. In FIG. 5B, the DCI activates the additional DL BWP in legacy UL slots, which are marked with dashed lines. In FIG. 5C, the DCI activates the additional BWP in all legacy slots, which are marked with dashed lines. The DCI may also indicate the time duration for the additional UL BWPs, additional DL BWPs, and the additional BWPs in FIGS. 5A-5C. Alternatively, the additional UL BWPs, the additional DL BWPs, and the additional BWPs in FIGS. 5A-5C may be available in a configured timer. The indication of BWP activation may be received from a DCI transmitted in a slot before the start of the timer.

The additional BWP might be configured with the same numerology or different numerologies with the legacy BWP, e.g., different CP and/or subcarrier spacing. This results in a different slot duration in the legacy BWP and in the additional BWP. With this, the configuration of the timer for the available additional BWP is based on absolute time e.g., number of milliseconds, instead of number of slots. The configured DL or UL additional BWP is available in each of DL or UL slot with the timer.

In some scenarios, in order to satisfy different traffic needs, the UE may switch BWPs. For example, when larger traffic is needed, the UE may switch from a BWP with a narrower band to a BWP with a wider band. The present disclosure proposes to perform the BWP switching among the additional BWPs based on the BWP switching among the legacy BWPs based on associations between legacy BWPs and additional BWPs.

An additional BWP may be associated with a legacy BWP, such that when there is BWP switching between legacy BWPs, BWP switching might happen correspondingly for the additional BWPs. The association between legacy BWPs and additional BWPs may be one-to-one association, many-to-one association, or one-to-many association. That is, one legacy BWP may be associated to one additional BWP, multiple BWPs may be associated to one additional BWP, or one BWP may be associated to multiple additional BWPs. The association between legacy BWPs and additional BWPs may be configured by the base station explicitly. In some other embodiments, the association is implicitly determined based on BWP IDs, e.g., a legacy BWP with a specific BWP ID is associated with an additional BWP with another specific ID. For example, the legacy BWP #0 is associated with the additional BWP #5.

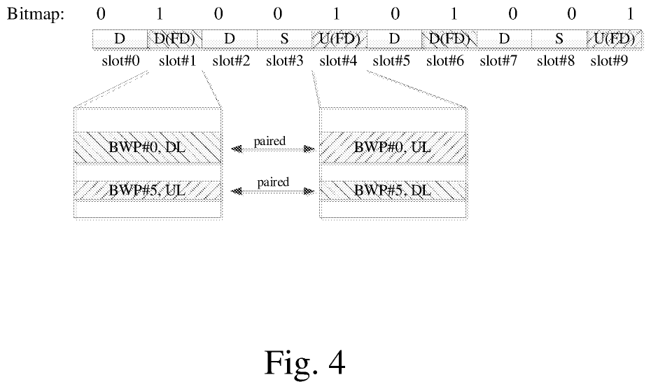

FIG. 6 illustrates an example of BWP switching between a legacy BWP and an additional BWP with BWP association according to some embodiments of the present disclosure.

In FIG. 6, legacy BWP #0 is associated with additional BWP #5, and the legacy BWP #1 is associated with additional BWP #6. When the UE receives an indication which indicates the BWP switching from legacy BWP #0 to legacy BWP #1, in the full duplex slot, for example, slot #1, the UE switches the additional UL BWP from BWP #5 to the additional UL BWP #6. Correspondingly, in DL slot #2, the UE also uses the DL BWP #1. Similarly, in the full duplex uplink slot #4, the UE switches the additional DL BWP from BWP #5 to the additional DL BWP #6, since as described the additional DL BWP and additional UL BWP are paired.

In some embodiments, an activated additional BWP might become deactivated automatically base on some certain events.

In the first case, when the UE receives an indication for BWP switching, after switching, the gap in frequency domain between the legacy BWP and the additional BWP does not meet the requirement of DL or UL resource separation, the additional BWP is deactivated autonomously. For example, in FIG. 6, according to the indication, the UE switches from legacy BWP #0 to legacy BWP #1, and switches from additional BWP #5 to additional BWP #6. If the gap between legacy BWP #1 and additional BWP #6 does not meet the requirement of DL/UL resource separation, then the additional BWP #6 is deactivated autonomously.

In the second case, when the UE receives an indication for BWP switching, which indicates the UE to switch to a legacy BWP without an associated additional BWP, the additional BWP that is available before the legacy BWP switching is deactivated autonomously. For example, the legacy BWP #0 is associated with additional BWP #5, the legacy BWP #1 is associated with additional BWP #6, and the legacy BWP #2 is not associated with any additional BWP. If the UE switches from legacy BWP #0 to legacy BWP #2, then the additional BWP #5 is deactivated autonomously.

In the third case, when initiating a RACH procedure, the UE determines whether PRACH occasions are configured in either the activated legacy BWP or in the additional BWP, or in both. If the UE founds that the PRACH occasions are configured in either the activated legacy BWP or in the additional BWP, or in both, the UE will initiate the PRACH procedure correspondingly in the BWP with RACH occasions. If the UE founds that no PRACH occasions is configured in both the activated legacy BWP and the activated additional BWP, the UE will switch the UL BWP to be initial UL BWP, and the additional UL BWP becomes deactivated automatically. In one embodiment, if additional DL BWP is configured, then the additional DL BWP becomes deactivated as well.

As mentioned above, in some scenarios, the UE is not capable of full duplex, and the full duplex is supported in BS only. The BS may indicate the UE to switch to an UL BWP in a legacy DL slot based on an indication, or indicate the UE to switch to a DL BWP in a legacy UL slot based on an indication. In one embodiment, the indication is carried in a DCI signaling, a MAC signaling, or an RRC signaling. This indication may be a newly defined field in the signaling for indicating the BWP switching. In another embodiment, the indication may reuse the legacy BWP switching indication, but extend the set of BWPs for BWP switching, and includes at least one BWP with an opposite link direction compared with other BWPs in the BWP set, i.e., to include a DL BWP in the set of UL BWPs, and/or a UL BWP in the set of DL BWPs.

With this, the BS can indicate a UE to switch to such a UL BWP in a DL slot for UL transmission, and/or indicate a UE to switch to such a DL BWP in a UL slot for DL reception.

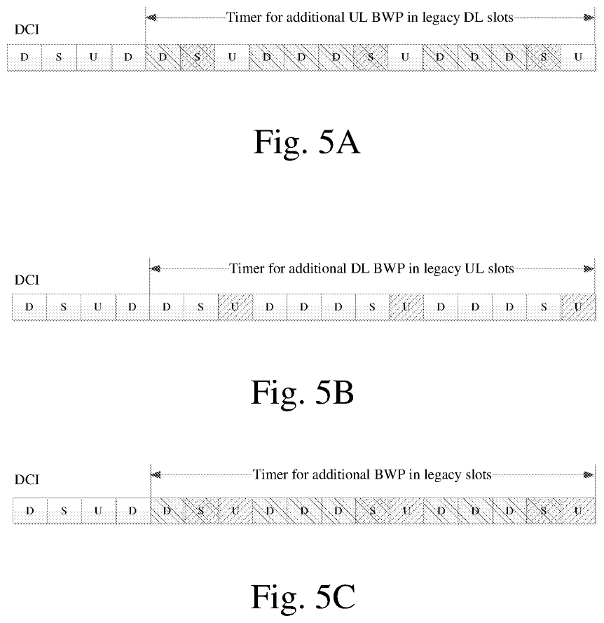

FIG. 7 illustrates an example of BWP switching from a legacy DL BWP in a legacy DL slot to a UL BWP based on an indication in BWP switching. The BWP set for switching includes four BWPs, BWP #1 for DL, BWP #2 for DL, BWP #3 for DL, and BWP #3 for UL. In DL slot #0, the UE receives a DCI, indicating the UE1 to perform the BWP switching from BWP #1 to BWP #3. Upon receiving this DCI, the UE1 perform BWP switching and could then transmit UL signal in the activated UL BWP #3 in the DL slot #2. In one embodiment, the BWP switching is a one-time switching, and in slot #4, UE1 still uses BWP #1 for UL transmission. In FIG. 2, UE2 is not instructed to perform the BWP switching, and always uses BWP #2 to perform the DL or UL transmission.

In another embodiment, an additional BWP might be activated for data transmission in a slot based on scheduling information received. For example, if the UE receives a DCI scheduling a UL transmission in a DL slot, the UE activates the additional UL BWP for UL transmission in the slot. Similarly, if a DCI is received for scheduling a DCI transmission in a UL slot, the UE activates the additional UL BWP for DL transmission in the slot.

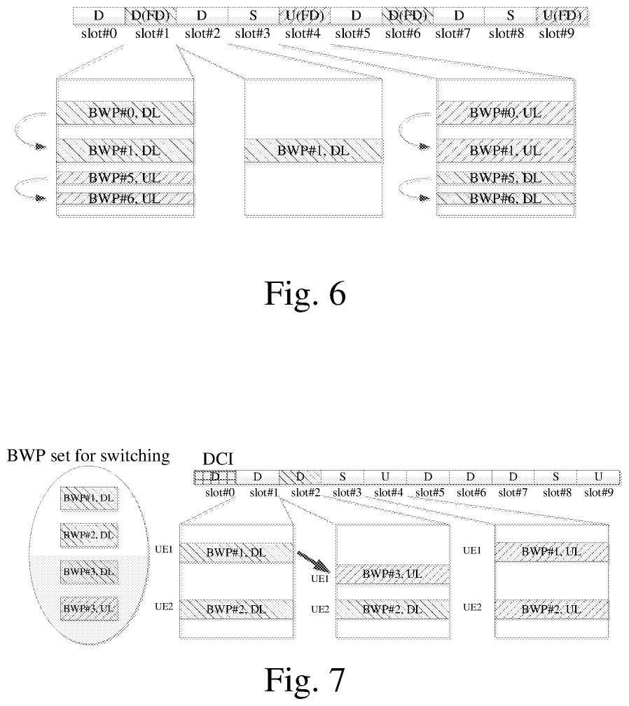

FIG. 8 illustrates a method performed between a UE and a BS for wireless communication according to a preferred embodiment of the present disclosure.

In step 801, the BS determines a first plurality of BWPs for a first set of slots, wherein the first set of slots are preconfigured for a first link, correspondingly, the UE also determines a first plurality of BWPs for a first set of slots. For example, in FIG. 4, the UE may determine legacy BWP #0 for DL slot, slot #1, and determine other legacy BWPs for other DL slots. In step 802, the BS transmits a configuration indicating utilizing a first BWP for the first set of slots for a second link, and the UE receives such a configuration. The first link may be the uplink and the second link may be the downlink, and vice versa.

In one embodiment, the first BWP is included in an additional plurality of BWPs. For example, as shown in FIG. 4, for slot #1, the UE determines BWP #0 for downlink transmission, and after receiving an indication, the UE uses BWP #5 for uplink. BWP #5 is selected from an additional plurality of BWPs. For another example, as shown in FIG. 7, for UE1, in slot #1, UE1 uses BWP #1 for downlink transmission, after receiving the DCI, in slot #2, the UE determines BWP #3 for uplink transmission, which is included in a BWP set for switching.

Based on the configuration, the UE may perform data transmission with the first plurality of BWPs for the first link and the first BWP for the second link in the same slot. For example, in FIG. 4, for slot #1, the UE performs the downlink transmission with BWP #0, and performs the uplink transmission with BWP #5.

The UE may also determine a second plurality of BWPs for a second set of slots, wherein the second set of slots is preconfigured for the second link. For example, in FIG. 4, the UE also determines legacy BWP #0 for UL slot, slot #4, and determine other legacy BWPs for other UL slots. The configuration received in step 802 may also indicate the UE to utilize a second BWP for the second set of slots for the first link. For instance, in FIG. 4, for slot #4, the configuration indicates that an additional BWP #5 for downlink transmission is configured for the UE to perform downlink transmission in the uplink slot #4. Similarly, the second BWP is included in an additional plurality of BWPs as the first BWP.

Based on the above, the UE may perform data transmission with the first plurality of BWPs for the first link and the first BWP for the second link in the same slot; and perform data transmission with the second plurality of BWPs for the second link and the second BWP for the first link in the same slot. Take slot #1 and slot #4 in FIG. 4 as an example, the UE performs data transmission with the BWP #0 for downlink and BWP #5 for the uplink in slot #1 in the same slot, and perform data transmission with the BWP #0 for uplink and BWP #5 for the downlink in slot #4 for the uplink in the same slot.

In some embodiments, each of the first plurality of BWPs has the same center frequency as a corresponding one in the second plurality of BWPs. Each of the first plurality of BWPs is paired with the corresponding one in the second plurality of BWPs, which has same BWP ID. Referring again to FIG. 4, the BWP #5 for uplink in slot #1 and BWP #5 for downlink in slot #4 have the same frequency, they are paired, and they have the same BWP ID.

In some embodiments, the configuration may be associated with an RRC signalling with a bitmap. For example, the bitmap in FIG. 4 indicate the configuration. In other embodiment, the configuration is associated with the DCI, such as the DCI as shown in FIGS. 5A-5C. The DCI may be is group common DCI or UE-specific DCI. The DCI is scrambled with a new RNTI.

In other embodiments, the configuration may further indicate a first time duration for activating the first BWP, and the configuration further indicates a second time duration for deactivating the first BWP. These time durations may also be controlled by one or more timers.

In some scenarios, each of the BWP in the first plurality of the BWPs is associated with a corresponding BWP of a first additional plurality of the BWPs configured for the UE, and a first BWP in the first plurality of the BWPs is associated with a first BWP of the first additional plurality of the BWPs. For example, in FIG. 6, for slot #1, BWP #0 in the plurality of legacy BWPs is associated with BWP #5 in the plurality of additional BWPs, and BWP #1 in the plurality of legacy BWPs is associated with BWP #6 in the plurality of additional BWPs.

When BWP switching happens between two BWPs in the first plurality of BWPs, BWP switching happens between two BWPs in the first additional plurality of BWPs associated with the two BWPs in the first additional plurality of BWPs. That is, based on the above association relationship, once switching from BWP #0 to BWP #1, BWP #5 is switched to BWP #6.

In some cases, the additional BWPs may be deactivated. For instance, when a gap between a BWP obtained after the BWP switching in the first plurality of BWPs and a BWP obtained after the BWP switching in the first additional plurality of BWP is less than a threshold, deactivating the BWP obtained after the BWP switching in the first additional plurality of BWP. Take FIG. 6 as an example, for slot #1, if BWP #1 for downlink and BWP #6 for uplink have a gap less than a predefined threshold, the additional BWP #6 is deactivated.

For another example, upon initiation of a RACH procedure, the UE may deactivate utilization of the first BWP if PRACH occasions are not configured in both the first BWP in the first plurality of the BWPs and the first BWP of the first additional plurality of the BWPs. That is, when the UE founds that no PRACH occasions is configured in both the activated legacy BWP and the activated additional BWP, the UE will switch the UL BWP to be initial UL BWP, and the additional UL BWP becomes deactivated automatically.

For yet another example, upon switching from a first BWP to a second BWP in the first plurality of the BWPs, the UE may deactivate the first BWP in the first additional plurality of the BWPs if no BWP in the first additional plurality of the BWPs is associated with the second BWP. Take FIG. 6 as an example, for slot #1, if BWP #1 does not has an associated BWP in the first additional plurality of the BWPs, after switching from BWP #0 to BWP #1, the additional BWP #5 is deactivated.

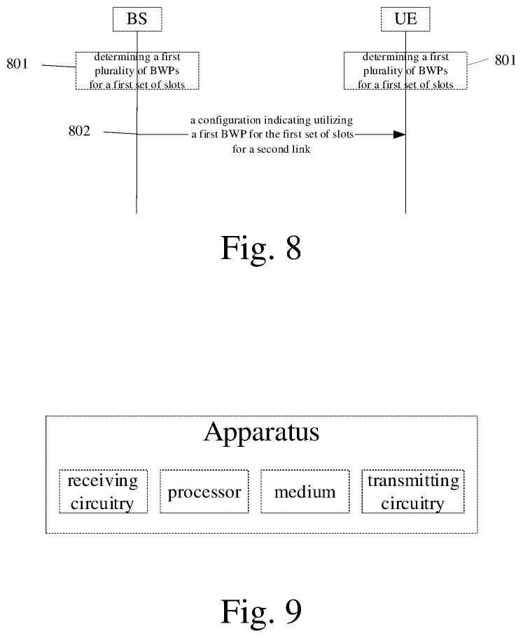

FIG. 9 illustrates a block diagram of an apparatus according to the embodiments of the present disclosure.

The apparatus may include a receiving circuitry, a processor, a medium and a transmitting circuitry. In one embodiment, the apparatus may include a non-transitory computer-readable medium having stored thereon computer-executable instructions; a receiving circuitry; a transmitting circuitry; and a processor coupled to the non-transitory computer-readable medium, the receiving circuitry and the transmitting circuitry. The computer executable instructions can be programmed to implement a method (e.g. the method in FIG. 8) with the receiving circuitry, the transmitting circuitry and the processor.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A method performed by a user equipment (UE), the method comprising:
determining a first plurality of bandwidth parts (BWPs) for a first set of slots, wherein the first set of slots are preconfigured for a first link; and
receiving, from a base station, a configuration indicating utilizing a first bandwidth part for the first set of slots for a second link,
wherein the first link is one of uplink and downlink and the second link is the other one of uplink and downlink.

2. The method of claim 1, wherein the first bandwidth part is included in a first additional plurality of bandwidth parts.

3. The method of claim 2, further comprising:
performing data transmission or reception with at least one of the first plurality of bandwidth parts for the first link and the first bandwidth part for the second link in a same slot.

4. The method of claim 1, further comprising:
determining a second plurality of bandwidth parts for a second set of slots, wherein the second set of slots are preconfigured for the second link.

5. The method of claim 4, wherein the configuration further indicates utilizing a second bandwidth part for the second set of slots for the first link.

6. The method of claim 5, wherein the second bandwidth part is selected from a second additional plurality of bandwidth parts for the first link.

7. The method of claim 6, further comprising:
performing data transmission with at least one of the first plurality of bandwidth parts for the first link and the first bandwidth part for the second link in a same slot; and
performing data transmission with the second plurality of bandwidth parts for the second link and the second bandwidth part for the first link in a same slot.

8. The method of claim 4, further comprising:
each of the first plurality of bandwidth parts has a same center frequency as a corresponding one in the second plurality of bandwidth parts.

9. The method of claim 4, further comprising:
each of the first plurality of bandwidth parts is paired with a corresponding one in the second plurality of bandwidth parts, which has a same bandwidth part ID.

10. The method of claim 1, wherein the configuration is associated with an RRC signaling with a bitmap.

11. The method of claim 1, wherein the configuration is associated downlink control information (DCI).

12. The method of claim 1, wherein the configuration further indicates a first time duration for activating the first bandwidth part.

13. The method of claim 1, wherein the configuration further indicates a second time duration for deactivating the first bandwidth part.

14. The method of claim 2, wherein each of the bandwidth part in the first plurality of the bandwidth parts is associated with a corresponding bandwidth part of a first additional plurality of the bandwidth parts configured for the UE, and a first bandwidth part in the first plurality of the bandwidth parts is associated with a first bandwidth part of the first additional plurality of the bandwidth parts.

15. The method of claim 14, wherein if bandwidth part switching happens between two bandwidth parts in the first plurality of BWPs, bandwidth part switching happens between two bandwidth parts in the first additional plurality of bandwidth parts associated with the two bandwidth parts in the first additional plurality of bandwidth parts.

16. A user equipment (UE), comprising:
at least one memory; and
at least one processor coupled with the at least one memory and configured to cause the UE to:
determine a first plurality of bandwidth parts (BWPs) for a first set of slots, wherein the first set of slots are preconfigured for a first link; and
receive, from a base station, a configuration indicating utilizing a first bandwidth part for the first set of slots for a second link,
wherein the first link is one of uplink and downlink and the second link is the other one of uplink and downlink.

17. The UE of claim 16, wherein the first bandwidth part is included in a first additional plurality of bandwidth parts.

18. The UE of claim 17, wherein the at least one processor is configured to cause the UE to perform data transmission or reception with at least one of the first plurality of bandwidth parts for the first link and the first bandwidth part for the second link in a same slot.

19. The UE of claim 16, wherein the at least one processor is configured to cause the UE to determine a second plurality of bandwidth parts for a second set of slots, wherein the second set of slots are preconfigured for the second link.

20. A processor for wireless communication, comprising:
at least one controller coupled with at least one memory and configured to cause the processor to:
determine a first plurality of bandwidth parts (BWPs) for a first set of slots, wherein the first set of slots are preconfigured for a first link; and
receive, from a base station, a configuration indicating utilizing a first bandwidth part for the first set of slots for a second link,
wherein the first link is one of uplink and downlink and the second link is the other one of uplink and downlink.
